(19) United States
(12) Patent Application Publication
(10) Pub. No.: US 2007/0015582 A1
(43) Pub. Date: Jan. 18, 2007

(54) Character management system and service method thereof

(76) Inventor: Jeong Won Ha, Gyeongkido (KR)

Correspondence Address: LADAS & PARRY LLP, 224 SOUTH MICHIGAN AVENUE, SUITE 1600, CHICAGO, IL, 60604, US

(21) Appl. No.: 10/567,669

(22) PCT Filed: Oct. 10, 2003
(86) PCT No.: PCT/KR03/02083

§ 371 Date: Feb. 9, 2006

(30) Foreign Application Priority Data
Aug. 25, 2003 (KR) 10-2003-0058601

(51) Int. Cl. A63F 13/00; A63F 9/24

(52) U.S. Cl. 463/40; 463/42; 463/1

(57) ABSTRACT

The present invention relates, in general, to a character management service system and service method using the same and, more particularly, to a character management service system and service method using the same, which allows the characters of online games to selectively develop offline, thus improving a user's satisfaction. In the method of providing a character management service, attributes of a user's own characters and characters to be developed, and a method of distributing the attributes are registered. A corresponding user downloads mini games, generates data about attribute variations, such as experience levels and ability levels, through play of the mini games, and receives the attribute variations from the mobile communication terminal. The data about the attribute variations according to factors are classified, the classified data are distributed to a plurality of characters registered by the user, and corresponding characters are developed.

### TECHNICAL FIELD

The present invention relates, in general, to a character management service system and service method using the same and, more particularly, to a character management service system and service method using the same, which allows characters used in online games to selectively develop offline, thus increasing a user's satisfaction.

### BACKGROUND ART

Generally, characters or avatars function to represent users online.

That is, characters or avatars are developed or grown into various forms online according to users' desires, thus expressing users' unique individualities.

The development or growth of characters has been mainly performed in online communities, games, etc.

However, in the case of characters used in online communities, only the appearances thereof are regarded as important, but the user's personalities can be sufficiently expressed through the corresponding characters.

In the meantime, since the development of characters in games can be performed toward users' desired ends depending on the extent of the users' interest and effort, it can be considered that characters express the users' personalities.

Of course, characters used in games as described above are different between games in that they are either temporary or continuous according to the property of a corresponding game.

For example, in the case of network games, a character, developed in a game, cannot be used in its previous state when a user accesses the game again, but it must regrow from its initial state. In the case of online games, not only is the continuous development of a character possible, but also the developed character can be continuously used or additionally developed when the user accesses the same game again in future.

That is, the development of characters is only temporary in network games, while the continuous development of characters is possible in online games.

This is due to the fact that, in network games, each character is managed by a personal computer of a corresponding user, while, in online games, each character is managed by an online game server.

However, there is a problem in that a character continuously developed in a corresponding online game can be developed only when the PC of a corresponding user is online.

Further, in online games, one user can have many characters, which should develop different attributes (for example, intelligence, physical strength, magic power, etc.) according to the individual natures thereof.

However, since the above-described character can be developed only when it is used online by a corresponding user and participates in a game, there is a problem in that it is difficult to uniformly develop all characters and it takes a lot of time to develop the characters.

Recently, users can participate in online games using their mobile communication terminals, thus enabling characters to develop regardless of spatial and temporal restrictions.

However, a process of developing characters through mobile communication terminals as described above is also problematic in that, at the time of developing one character, other characters cannot develop, and the communication expense increases due to the use of mobile communication.

Moreover, there is a problem in that the development of characters using mobile communication terminals is performed under independent control without interconnecting with other users according to the attributes thereof, thus decreasing interest in online games.

That is, conventional character-related technologies are disadvantageous in that they are implemented by a provider-centered system that considers the rules of each Internet site as important, rather than a user-centered system, thus decreasing the users' convenience.

### DISCLOSURE OF THE INVENTION

Accordingly, the present invention has been made keeping in mind the above problems occurring in the prior art, and an object of the present invention is to provide a character management service system and service method, which can increase efficiency in managing a plurality of characters belonging to each user, provide interest in games to allow users to actively participate in games, and interconnect users with other users through mobile communication terminals.

In order to accomplish the above object, the present invention provides a character management system, comprising one or more game servers constructed to create one or more characters for each of users online, and provide game environments where the created characters can be developed, that is grown, with the characters being connected to the game servers online; one or more game database (DB) servers connected to the game servers, respectively, and constructed to allow the characters, created by the users, to be classified according to the user and registered in the game DB servers; a character management server constructed to manage the characters of the users registered in the game DB servers, classify ability levels or experience levels according to factors, store therein a plurality of mini games that can be played through mobile communication terminals to allow the mini games to be downloaded to the mobile communication terminals, and selectively distribute data about ability levels or experience levels acquired by the users to ability levels or experience levels of a plurality of characters of a corresponding user; and the mobile communication terminals of users constructed to acquire ability levels and experience levels by playing mini games downloaded from the character management server, and transmit data about acquired attribute variations to the character management server.

Further, the present invention provides a method of providing a service for managing characters of each user using a character management server, comprising 1) registering attributes of a user's own characters and characters to be developed, and a method of distributing the attributes; 2) allowing a corresponding user to download mini games to the user's mobile communication terminal, generate data about attribute variations, such as experience levels and ability levels, through play of mini games, and receive the attribute variations from the mobile communication terminal; and 3) classifying the data about the attribute variations according to factors, distributing the classified data to a plurality of characters registered by the user and developing corresponding characters.

### BRIEF DESCRIPTION OF THE DRAWINGS

FIG. 1 is a schematic view showing the construction of a character management service system according to the present invention;

FIG. 2 is a flowchart of a process of setting a character management method while interconnecting with users during a management process for providing the service by a character management server according to the present invention;

FIG. 3 is a flowchart of a process of developing characters by users during a process of providing a character management service according to the present invention; and

FIG. 4 is a flowchart of a process of updating attributes of characters by the character management server on the basis of varied attribute data during a process of providing the character management service according to the present invention.

Description of reference characters of important parts
110: game server
120: game DB server
130: authentication server
140: character management server
150: mobile communication terminal
160: interconnection server

### BEST MODE FOR CARRYING OUT THE INVENTION

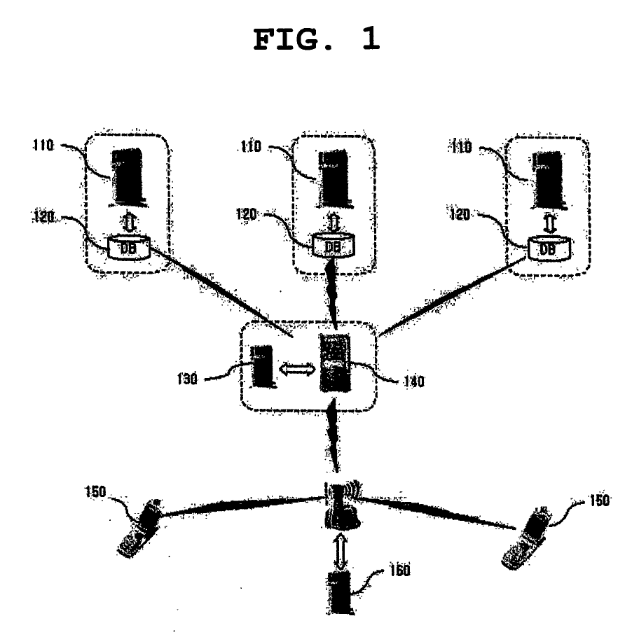

Hereinafter, embodiments of a character management system and service method using the same according to the present invention will be described in detail with reference to FIGS. 1 to 4.

FIG. 1 schematically illustrates the construction of a character management system according to the present invention.

The character management system of the present invention includes game servers 110, game database (DB) servers 120, an authentication server 130, a character management server 140 and mobile communication terminals 150.

In this case, the game servers 110 are constructed to create users' characters online and provide game environments where the created characters can be developed or grown, with the characters being online. One or more game servers 110 can be provided.

That is, each of the game servers 110 is a typical game providing server constructed to allow a plurality of users to simultaneously access the server online, and allow the users, simultaneously accessing the server, to play online games.

In this case, the game servers 110 provide different types of games and allocate attributes or experience levels to characters through corresponding games so that the attributes or experience levels are differentially or uniformly provided according to the rule of each game.

The game DB servers 120 are databases of corresponding game servers 110, constructed to match the game servers 110 in a one-to-one manner, and function to allow characters, created by respective users through the game servers 110, to be classified and stored therein with respect to users.

In this case, characters for respective users stored in the game DB servers 120 are designed so that the attributes or experience levels thereof are registered as data, and classified using accounts preset by corresponding users, that is, Identifications (IDs).

The authentication server 130 is constructed to authenticate a corresponding user when the user accesses an online game through the verification of a password corresponding to the ID of each user.

The character management server 140 is permitted by the game servers 110 to access attributes or experience levels allocated to the characters of the game servers 110. Further, the character management server 140 additionally manages sites (Websites or Wireless Application Protocol (WAP) sites) accessible online through the users' personal terminals, that is, PCs or mobile communication terminals 150. The character management server 140 allows the users to designate game characters and to select the attributes of characters needing to grow and develop the characters. Further, the character management server 140 is constructed to allow users to receive the result data of game play from the mobile communication terminals, classify the result data into various types of attributes on the basis of a preset classification method, and transmit the classified data to corresponding game DB servers according to a distribution type preset by a corresponding user.

Further, in the character management server 140, a plurality of mini games, such as a brick laying game, a card game, a flight simulation game, or a quiz game, are registered to enable the mini games to be downloaded to the users' mobile communication terminals 150.

Further, each of the users' mobile communication terminals 150 is constructed to be able to download and play the mini games registered in the character management server. Further, in each mobile communication terminal, a separate program programmed to transmit various pieces of data related to the game results, downloaded and played offline, to the online character management server 140, is installed.

Of course, the mobile communication terminals 150 are constructed to be able to access the online game environments provided from the game servers 110 through a mobile communication network, thus performing the growth and development of specific characters online.

Further, the above-described character management system according to the embodiment of the present invention further includes an interconnection server 160 that allows a plurality of users to interconnect with each other so as to simultaneously perform the development of experiences and capabilities of characters while forming guilds, parties or groups thereamong.

At this time, the interconnection server 160 is implemented with the server of a mobile communication company or a separate Internet Data Center (IDC) so as to allow the mobile communication terminals 150 of the users to interconnect with each other using mini games, Short Message Service (SMS), etc.

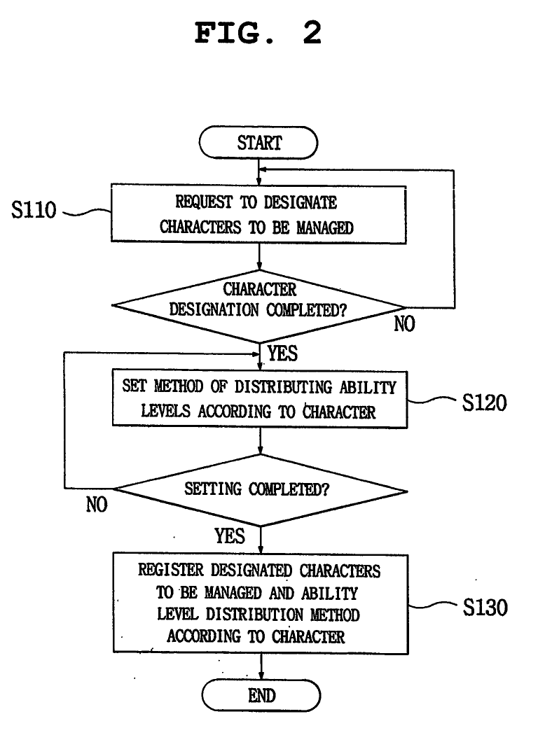

Hereinafter, a method of providing a character management service using the construction of the embodiment of the present invention is described in detail with reference to FIGS. 2 to 4.

First, the flowchart of FIG. 2 shows a process of setting a character management method while interconnecting with users during a management process for providing the service by the character management server according to the present invention.

As shown in the drawing, the character management server 140 is connected to the game servers 110 and makes a contract with the game servers 110 in advance so as to acquire the characters of respective games and attribute details thereof.

Therefore, the character management server 140 requests the users to designate their characters to be managed through sites managed online at step S110.

In this case, the characters to be managed represent characters generated by corresponding users and maintained thereby through the game servers 110 interconnected with the character management server 140.

That is, the character management server 140 requests the users to select characters, the attributes of which are desired to be developed, among characters classified according to users, from the game DB servers 120 connected to the game servers 110.

It is preferable that the character management server 140 acquires the details of the users' own characters and displays the character details on a screen while interconnecting with the game servers 110, thus enabling the users to select the character details.

It is preferable that, when a corresponding user subscribes to the service, the character management server 140 receives and registers, in advance, information about the details, such as the IDs and characters of the game servers 110 to which the user has subscribed and passwords thereof so as to upgrade the characters of the game servers 110.

Further, in the above process, the characters can be set so that the ability levels of all characters belonging to a corresponding user can be uniformly improved, but it is preferable to set an ability level distribution method for improving ability levels of part of the characters at step S120.

That is, the ability level distribution method enables the ability levels of only a specific character to improve as the occasion demands, for example, it allows a character, needing to improve its attack power, to acquire a higher ability level for attack power than that of other characters.

Therefore, if the character needing to improve its ability level is registered by the corresponding user, and the ability level distribution method for the characters is set by the user, the character management server registers information about the designated characters to be managed and the set ability level distribution method according to characters at step S130. Of course, in the character management server 140, information (phone numbers, etc.) about the users' mobile communication terminals 150 is registered together with the above information.

If a corresponding user's own character does not exist in the game DB servers 120 during the execution of the above-described process, the character management server 140 requests the user to first create a character using a site managed by the corresponding game server 110.

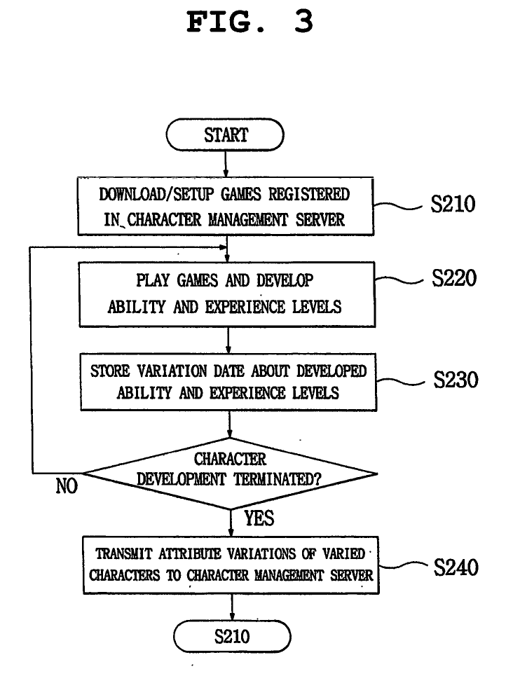

Further, the flowchart of FIG. 3 shows a process of acquiring ability levels and attributes by users after the above-described process has been completed.

That is, after various user settings are first performed in the character management server, the user downloads any one of various mini games registered in the character management server 140 and sets up the downloaded mini program on the mobile communication terminal 150 at step S210.

In this case, the mini game can be played on the mobile communication terminal 150, and may be a brick laying game, a card game, a flight simulation game, a quiz game, etc. Further, mini games similar to the corresponding game can be supported by the games servers 110.

Further, after the user downloads the mini game through the above process at step S210 and stores the mini game in the mobile communication terminal 150, the user develops an ability level or experience level by playing the mini game set up on the mobile communication terminal 150 at step S220.

For example, intelligence is developed through a mini game such as a block laying game, and an experience level and physical strength or fighting power can be developed through a mini game such as a flight simulation game.

The game can be played not only offline but also online by allowing the user to access each online game through a mobile communication network according to the user's selection and to develop an ability level and an experience level while playing the downloaded game.

In particular, the user can develop characters while interconnecting with other users that form a relationship with the user in the form of a guild, a party or a union.

This operation means that short messages are exchanged with other users through the interconnection server 160, such as the server of a mobile communication company or an IDC server, thus enabling characters to interconnect through the interconnection between users.

Information about the ability level, experience level, etc., developed through the above-described process, is stored in the memory of the mobile communication terminal 150 of the corresponding user as data at step S230.

In this case, since the data can be continuously updated on the mobile communication terminal 150, the corresponding user can develop an ability level and an experience level without temporal and spatial restrictions.

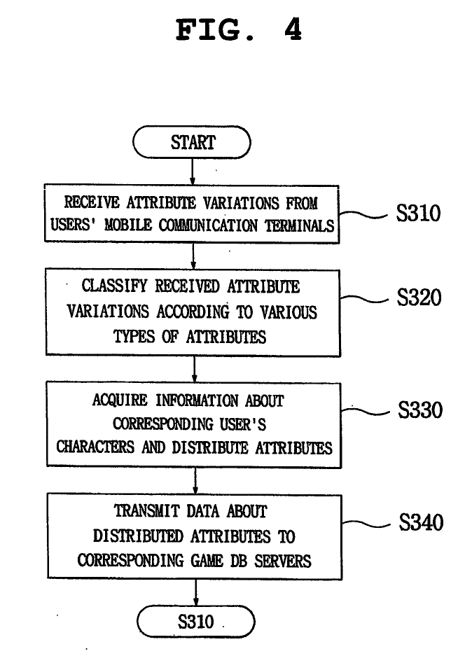

Further, the flowchart of FIG. 4 shows a management process by the character management server that updates ability and experience levels obtained offline by each user as characters stored in respective game DB servers.

That is, while the ability level and the experience level of the corresponding user are continuously updated on the mobile communication terminal 150 of the user, the character management server 140 continuously, periodically or selectively obtains the result data of the played game from the user's own mobile communication terminal 150 at step S310.

At this time, the result data may include the number of games played, game playing time, score, etc.

For example, if the user plays a flight simulation game, among the games on the mobile communication terminal 150, the character management server 140 receives data varied with the play of the game, such as data about the number of games played, game playing time, and score, from the mobile communication terminal 150.

In this case, it is preferable that the data be periodically transmitted by the mobile communication terminal 150 to the character management server 140 to allow the character management server 140 to receive the varied data.

Of course, as shown in the flowchart of FIG. 3, when the user terminates the development of ability and experience levels stored in the mobile communication terminal 150, and then desires to register information data about the developed attribute variations in the game DB server 120, the information data stored in the mobile communication terminal 150 can be transmitted to the character management server 140 at step S240.

Moreover, the corresponding mobile communication terminal 150 can access a site managed by the character management server 140 online, and transmit the data about the attribute variations to the character management server 140.

Further, the character management server 140, having received the data about the attribute variations through the above process, classifies the received data according to various types of attributes, that is, factors, at step S320.

In this case, the factors include at least one of a factor having an attribute of attack power, a factor having an attribute of defense power, a factor having an attribute of intelligence, and a factor having an attribute of magic power.

Specially, classification according to factors is performed by, for example, a method of allocating a predetermined ability level and experience level for attack power and defense power when the number of games played is high or game playing time has continued for a long time.

Next, the character management server 140 distributes ability levels to respective characters set by the user on the basis of the information data about the classified ability levels and the ability level distribution method preset by the corresponding user at step S330.

For example, if the characters registered by the user are set to uniformly develop their attributes, increase the physical strength of one of a plurality of characters of the user and increase the attack power of another character thereof, the attribute about physical strength, among various attributes obtained by the corresponding user classified by the character management server 140, is distributed to one character, and the attribute about attack power is distributed to another character.

Thereafter, the character management server 140 transmits the data about attributes distributed through the above process to a game DB server 120 in which the corresponding characters are stored at step S340, thus enabling the game DB server 120 to upgrade the attributes for the characters.

In this case, the game DB server 120 can update attributes for the characters when the user re-accesses the corresponding online game later, and can perform the update simultaneously with the reception of the data.

Consequently, if the user re-accesses the online game managed by the specific game server 110 later through the above process, the user can develop and grow the characters as updated characters.

### INDUSTRIAL APPLICABILITY

As described above, the present invention can obtain the following various advantages through a character management system and method of providing a character management service using the same.

First, the present invention is advantageous in that it can continuously develop and grow respective characters offline as well as online.

Since the development of characters offline can be performed through mobile communication terminals, the development of characters is not temporally and spatially restricted.

Further, the present invention is advantageous in that a user can interconnect with other users using SMS through mobile communication terminals even when offline, thus increasing interest in games.

Further, the present invention is advantageous in that it can simultaneously develop a plurality of characters through the utilization of one character and conveniently manage a plurality of characters, thereby improving users' favorable response to characters.

1. A character management system, comprising:
one or more game servers constructed to create one or more characters for each of users online, and provide game environments where the created characters can be developed, that is grown, with the characters being connected to the game servers online;
one or more game database (DB) servers connected to the game servers, respectively, and constructed to allow the characters, created by the users, to be classified according to the user and registered in the game DB servers;
a character management server constructed to manage the characters of the users registered in the game DB servers, classify ability levels or experience levels according to factors, store therein a plurality of mini games that can be played through mobile communication terminals to allow the mini games to be downloaded to the mobile communication terminals, and selectively distribute data about ability levels or experience levels acquired by the users to ability levels or experience levels of a plurality of characters of a corresponding user; and
the mobile communication terminals of users constructed to acquire ability levels and experience levels by playing mini games downloaded from the character management server, and transmit data about acquired attribute variations to the character management server.

2. The character management system according to claim 1, further comprising an interconnection server implemented with a server of a mobile communication company or a separate Internet Data Center (IDC) to develop experience levels, ability levels, etc. of the characters while interconnecting between the mobile communication terminals of the users through the use of mini games, Short Message Service (SMS), etc.

3. A method of providing a character management service using a character management server, comprising:
1) registering attributes of a user's own characters and characters to be developed, and a method of distributing the attributes;
2) allowing a corresponding user to download mini games to the user's mobile communication terminal, generate data about attribute variations, such as experience levels and ability levels, through play of mini games, and receive the attribute variations from the mobile communication terminal; and
3) classifying the data about the attribute variations according to factors, distributing the classified data to a plurality of characters registered by the user and developing corresponding characters.

4. The character management service method according to claim 3, wherein the step 1) comprises:
obtaining characters of games while interconnecting with respective game servers;
displaying the obtained characters to allow one of the characters to be selected; and
inducing the user to select and register attributes to be developed, among attributes of the characters selected by the user, and a method of distributing the attributes.

5. The character management service method according to claim 3, wherein the step 1) comprises further registering information about details, such as IDs or passwords of game servers to which the user subscribes, at the time of registration.

6. The character management service method according to claim 3, wherein the mini game at step 2) is a game that is programmed and registered in advance to allow experience levels and ability levels to be classified through the number of games played or score of a game and to be downloaded to the mobile communication terminal of a corresponding user.

7. The character management service method according to claim 3, wherein the receiving of data about the attribute variations at step 2) is performed to allow the corresponding mobile communication terminal to access the character management server and receive the data as occasion demands.

8. The character management service method according to claim 3, wherein the receiving of data about the attribute variations at step 2) is performed to allow the character management server to continuously access the user's mobile communication terminal and to receive the data.

9. The character management service method according to claim 3, wherein the factors at step 3) includes at least one of a factor having an attribute of attack power, a factor having an attribute of defense power, a factor having an attribute of intelligence, and a factor having an attribute of magic power.
